(19) United States
(12) Patent Application Publication
(10) Pub. No.: US 2026/0296831 A1
(43) Pub. Date: Oct. 1, 2026

(54) ELEVATOR CONTROL SYSTEM AND ELEVATOR CONTROL METHOD

(71) Applicant: HYUNDAI ELEVATOR CO., LTD., Chungcheongbuk-do (KR)

(72) Inventor: Jihye SEO, Chungcheongbuk-do (KR)

(21) Appl. No.: 19/480,892

(22) PCT Filed: May 8, 2024
(86) PCT No.: PCT/KR2024/006183

§ 371 Date: Nov. 3, 2025

(30) Foreign Application Priority Data
May 11, 2023 (KR) 10-2023-0061025

(51) Int. Cl. B66B 1/34

(52) U.S. Cl. CPC B66B 1/3407; B66B 2201/235; B66B 2201/241

(57) ABSTRACT

An elevator control system is disclosed. The elevator control system includes: a data processing unit configured to process elevator operation information; a data storage unit configured to store the elevator operation information, the elevator operation information including call-by-call data including a date and time at which each call occurred and a floor on which each call occurred; an analysis unit configured to predict a target floor of an elevator based on the elevator operation information; and an elevator control unit configured to move the elevator to the predicted target floor.

### TECHNICAL FIELD

The present disclosure relates to an elevator control system and an elevator control method.

### BACKGROUND ART

In a building with an elevator, a floor where an elevator call occurs frequently may vary depending on characteristics of the building, users of the building, and times of day when the building is used. Typically, an elevator remains at its last destination floor or automatically returns to a lobby to await the next call. In response to a call, the elevator moves to the requested floor. Here, the farther the elevator is from the floor where the call occurs, the longer the user's waiting time will be. This can lead to inefficient operation of the elevator.

### RELATED PATENT DOCUMENT

Korean Patent Laid-open Publication No. 10-1999-012986
Korean Patent Laid-open Publication No. 10-2000-0076382

### DISCLOSURE

### Technical Problem

It is an aspect of the present disclosure is to provide an elevator control system and method that can ensure efficient operation of an elevator by moving the elevator in advance to a floor on which a call is expected to occur.

### Technical Solution

In accordance with one aspect of the present disclosure, an elevator control system includes: a data processing unit configured to process elevator operation information; a data storage unit configured to store the elevator operation information, the elevator operation information including call-by-call data including a date and time at which each call occurred and a floor on which each call occurred; an analysis unit configured to predict a target floor of an elevator based on the elevator operation information; and an elevator control unit configured to move the elevator to the predicted target floor.

In one embodiment, the analysis unit may be configured to organize the call-by-call data on a daily basis to generate a call count matrix with a horizontal axis representing time and a vertical axis representing a floor on which each call occurred.

In one embodiment, the analysis unit may be configured to generate a weighting matrix having the same dimensionality as the call count matrix based on a period of time over which the elevator operation information is compiled and to generate a score matrix by multiplying the call count matrix by the weighting matrix.

In one embodiment, the elevator control unit may be configured to determine whether the elevator is in operation and to move the elevator to the target floor in response to determining that the elevator is not in operation.

In one embodiment, the elevator control unit may be configured to receive an elevator call from a user and to operate the elevator based on the elevator call, regardless of whether the elevator is being moved to the target floor, in response to receiving the elevator call,

In one embodiment, the data storage unit may be configured to group the call-by-call data on the basis of at least one of day of the week, time, and destination floor and to store the grouped data.

In accordance with another aspect of the present disclosure, an elevator control method using an elevator control system includes: receiving and storing elevator operation information; analyzing the elevator operation information to generate call-by-call data comprising a floor on which each elevator call occurred and a time at which each elevator call occurred; generating a call count matrix with a horizontal axis representing time and a vertical axis representing a floor on which each elevator call occurred, based on the call-by-call data; predicting a target floor of an elevator based on the call count matrix; and moving the elevator to the target floor.

In one embodiment, the step of predicting a target floor of an elevator based on the call count matrix may include: generating a weighting matrix having the same dimensionality as the call count matrix based on a period of time over which the elevator operation information is compiled; generating a score matrix by multiplying the call count matrix by the weighting matrix; and predicting a target floor of the elevator based on the score matrix.

In one embodiment, the elevator control method may further include: receiving an elevator call from a user; and operating the elevator based on the elevator call, regardless of whether the elevator is being moved to the target floor, in response to receiving the elevator call.

In one embodiment, the step of generating a call count matrix with a horizontal axis representing time and a vertical axis representing a floor on which each elevator call occurred based on the call-by-call data may include: grouping the call-by-call data on the basis of at least one of day of the week, time, and destination floor and storing the grouped data.

### Advantageous Effects

Embodiments of the present disclosure provide an elevator control system and elevator control method that can ensure efficient operation of an elevator by moving the elevator in advance to a location at which an elevator call is expected to occur at preset time intervals (for example, at time intervals of seconds or minutes).

### DESCRIPTION OF DRAWINGS

FIG. 1 is a block diagram of an elevator control system according to one embodiment of the present disclosure.

FIG. 2 is a block diagram of an elevator control system according to another embodiment of the present disclosure.

FIG. 3 is a block diagram of an elevator control system according to a further embodiment of the present disclosure.

FIG. 4 is a flowchart of a method of storing elevator operation information according to one embodiment of the present disclosure.

FIG. 5 is a flow diagram of an elevator control method according to one embodiment of the present disclosure.

FIG. 6 to FIG. 8 are matrices for predicting an expected location of an elevator according to one embodiment of the present disclosure.

### BEST MODE

Hereinafter, embodiments of the present invention will be described in detail with reference to the accompanying drawings such that the present invention can be easily implemented by those skilled in the art. It should be understood that the present invention may be embodied in different ways and is not limited to the following embodiments.

In the drawings, portions irrelevant to the description will be omitted for clarity. Like components will be denoted by like reference numerals throughout the specification.

As used herein, the terms “includes”, “comprises”, “including” and/or “comprising” specify the presence of stated features, steps, operations, elements, and/or components, but do not preclude the presence or addition of one or more other features, steps, operations, elements, components, and/or groups.

It will be understood that the invention described in this disclosure is not intended to be limited to any particular embodiment, and includes various modifications, equivalents, and/or alternatives to the embodiments of this disclosure.

As used herein, the expression “configured to” may be used interchangeably with, for example, “suitable for”, “having the capacity to”, “designed to”, “adapted to”, “made to”, or “capable of” depending on the context. The expression “configured (or set up) to” may not necessarily mean “specifically designed (hardware wise) to”. Instead, in a certain context, the expression “a device configured to” may mean that the device is “capable of” doing something in conjunction with other devices or components.

It will be understood that the related literature described in this disclosure is incorporated herein by reference in its entirety and that a person having ordinary skill in the art will be able to apply what is described in the related literature to the matters briefly described herein.

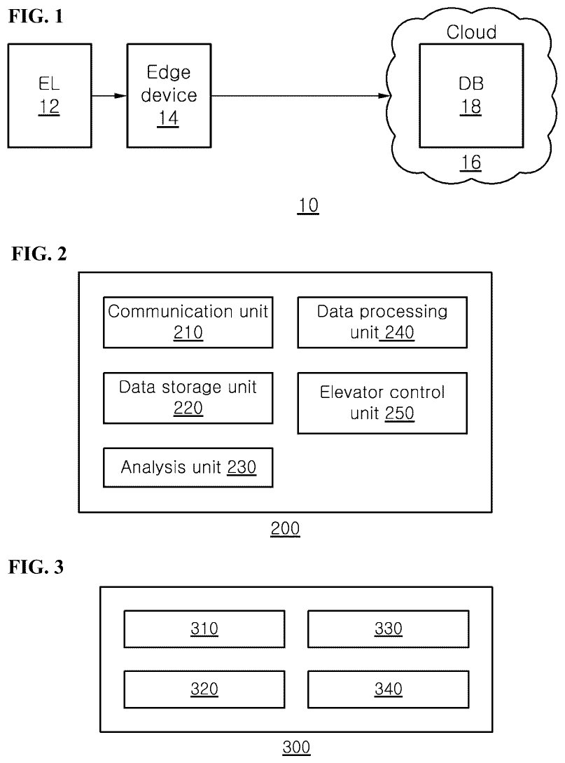

FIG. 1 is a block diagram of an elevator system 10 according to one embodiment of the present disclosure.

Referring to FIG. 1, the elevator system 10 includes: an elevator management device 12, an edge device 14, and a cloud environment 16. The elevator management device 12 may include a control panel configured to control an elevator. The edge device 14 may include physical hardware situated at a remote location on a network edge. The edge device 14 may include resources such as a memory, a processor, and the like, which are able to collect, process, and execute data in real time with limited assistance from the cloud environment 16. Although the elevator management device 12 and the edge device 14 are shown as separate components in FIG. 1, it should be understood that this is for illustration only and the elevator management device 12 and the edge device 14 may be integrated into a single device to be provided to a building where the elevator is installed. In one embodiment, the edge device 14 may include any device (for example, a computing device, a smart device, and the like) that includes a memory and a processor and is able to be connected to the cloud environment 16 to utilize a database 18 of the cloud environment 16. It should be understood that the cloud environment 16 may include a database 18 and a component required to perform general server functions. For example, the cloud environment 16 may be understood as a cloud server. The database 18 of the cloud environment 16 may be configured to store data received from the edge device 14.

In one embodiment, the edge device 14 is configured to send elevator operation information to the database 18 of the cloud environment 16. The edge device 14 may be configured to send the elevator operation information at preset time intervals. Accordingly, the elevator operation information may be accumulated in the database 18 of the cloud environment 16. The edge device 14 may also store the elevator operation information in a memory thereof. The edge device 14 may be configured to implement an algorithm for determining on which floor the elevator will be located at preset time intervals based on the data accumulated in the database 18 of the cloud environment 16. Alternatively, the cloud environment 16 may be configured to implement an algorithm for determining on which floor the elevator will be located at preset time intervals based on the accumulated data. That is, the cloud environment 16 may implement an algorithm for determining on which floor the elevator will be located and send the algorithm to the edge device 14. In one embodiment, the edge device 14 and the cloud environment 16 may operate like a distributed computing system.

Although the edge device 14 and the cloud environment 16 are shown as separate components in FIG. 1 for descriptive convenience, it should be understood that, when a method performed by the edge device 14 and a method performed by the cloud environment 16 are performed by a single management entity, these methods may be described as being performed by a single device. Additionally, it should be understood that the edge device 14 may directly perform elevator control, or the cloud environment 16 may perform elevator control. Additionally, steps performed by the edge device 14 may be performed by the cloud environment 16, or vice versa.

In one embodiment, the edge device 14 is configured to generate a prediction algorithm that predicts a floor from which the elevator is expected to be called, based on the accumulated elevator operation information. The edge device 14 may update the prediction algorithm based on the accumulated elevator operation information at preset time intervals, for example, at time intervals of seconds (for example, 1, 2, 3, 4, 5, . . . 10, 20, 30 seconds, and the like), minutes (for example, 1, 2, . . . 10 minutes, and the like), hours, days, weeks, or months. The edge device 14 may receive the accumulated elevator operation information from the cloud environment 16. Using the prediction algorithm, the edge device 14 may predict on which floor the elevator will be located at preset time intervals, for example, at time intervals of seconds (for example, 1, 2, 3, 4, 5, . . . 10, 20, 30 seconds, and the like), minutes (for example, every 1, 2, . . . 10 minutes, and the like.), hours, and the like.

The elevator management device 12 may be configured to collect elevator operation information and send the collected elevator operation information to the edge device 14. The elevator management device 12 may be configured to collect elevator operation information and send the collected elevator operation information the edge device 14 every preset time interval, such as milliseconds, seconds, minutes, or the like. The edge device 14 may be configured to send the elevator operation information to the cloud environment 16 every preset time interval, such as milliseconds, seconds, minutes, or the like. The elevator operation information sent from the elevator management device 12 to the edge device 14 may be contained in data in hexadecimal format (raw data). The edge device 14 or the cloud environment 16 may be configured to extract the elevator operation information from the data in hexadecimal format. In one embodiment, extraction of the elevator operation information from the data in hexadecimal format may be referred to as “data preprocessing”. It should be understood that the data in hexadecimal format is merely illustrative and data containing the elevator operation information may be in other data formats. In one embodiment, the elevator operation information may include a time at which a call (a car call, a hall call) occurred (including date, day of the week, hour, minute, second, whether it is a weekend, and whether it is a public holiday), movement direction, waiting time, and the like. The elevator operation information may include characteristics of the elevator, including a top floor, a rated speed, a mainboard version thereof, and the like. The edge device 14 or the cloud environment 16 may group (or organize) the extracted elevator operation information into a desired data set and may store the data set. For example, the organized data set may be stored in a storage unit (not shown) of the edge device 14 or in the database 18 of the cloud environment 16. In one embodiment, the organized data set may include a time at which each elevator call occurred (for example, day of the week, hour, minute), a floor on which each elevator call occurred, and a destination floor.

In one embodiment, the database 18 of the cloud environment 16 may store the raw data, or may store the elevator operation information extracted from the raw data.

The edge device 14 may send results of applying the prediction algorithm to the elevator management device 12, and the elevator management device 12 may move the elevator to a floor from which the elevator is expected to be called, based on the results.

That is, the edge device 14 or the cloud environment 16 may determine a floor from which the elevator is expected to be called at preset time intervals using the prediction algorithm based on the elevator operation information and may move the elevator to the corresponding floor based on results of determination.

FIG. 2 is a block diagram of an elevator control system 200 according to another embodiment of the present disclosure. Although the elevator control system 200 is shown as a single entity in FIG. 2, it should be understood that components 210, 220, 230, 240, 250 of the elevator control system 200 may be distributed between an edge device 14 and a cloud environment 16 since the elevator control system 200 includes the edge device 14 and the cloud environment 16.

Referring to FIG. 2, the elevator control system 200 includes a communication unit 210, a data storage unit 220, an analysis unit 230, a data processing unit 240, and an elevator control unit 250.

The communication unit 210 is configured to communicate with external devices via a network. In one embodiment, both the edge device 14 and the cloud environment 16 include the communication unit. The communication unit 210 may be configured to enable communication between at least two components among the data storage unit 220, the analysis unit 230, the data processing unit 240, and the elevator control unit 250. The data storage unit 220 is configured to store elevator operation information. The data storage unit 220 may store raw data received from an elevator management device 12. The data storage unit 220 may store raw data processed by the elevator management device 12 as the elevator operation information. The data storage unit 220 may store a prediction algorithm. The data storage unit 220 may store a prospective target floor determined using the prediction algorithm. The data storage unit 220 may also store a record of whether a call actually occurred at the prospective target floor for every prediction.

That is, the data storage unit 220 may store all information related to elevator operation. The data storage unit 220 may be configured to store a matrix, such as those shown in FIG. 6 to FIG. 8.

In one embodiment, the analysis unit 230 may generate a prediction algorithm based on the elevator operation information. In addition, the analysis unit 230 may determine a prospective target floor of the elevator using the prediction algorithm.

The data processing unit 240 is configured to process raw data collected by the elevator management device 12 to extract elevator operation information used by the prediction algorithm. In one embodiment, when the raw data is in hexadecimal format, the data processing unit 240 may analyze the raw data to generate call-by-call data including at least one of the following: a time at which each call occurred (for example, day of the week, hour, minute), a floor on which each call occurred, and a destination floor. The data processing unit 240 may process consecutive sets of data generated during a preset period of time (such as, milliseconds, seconds, minutes, hours, and the like). For example, the data processing unit 240 may process data generated during a preset period of time (such as, one second, one minute, and the like) to organize data by a method of assigning an ID by matching each call with a time at which a corresponding call occurred (for example, day of the week, hour, minute), a floor on which the call occurred, a destination floor, a waiting time, and the like. The data organized as above may be referred to as “call-by-call data”. Each call-by-call datum may be assigned one ID. Call-by-call elevator operation information processed by the data processing unit 240 may be stored in the data storage unit 220.

In addition, the data processing unit 240 may analyze elevator operation information stored in the data storage unit 220 to organize the call-by-call data on the basis of at least one of the following: date, holiday, day of the week, hour, minute, destination floor, and call-occurrence floor. The data processing unit 240 may extract the call-by-call data on the basis of date, holiday, and day of the week, may extract the call-by-call data on the basis of hour and minute, and may extract the call-by-call data on the basis of destination floor and call-occurrence floor. The data extracted and organized as above may be stored in the data storage unit 220.

The analysis unit 230 may arrange the call-by-call elevator operation information stored in the data storage unit 220 to generate a matrix such as those shown in FIG. 6 to FIG. 8, and may determine a prospective target floor of the elevator using the matrix.

In one embodiment, the analysis unit 230 may retrieve the call-by-call data on a daily basis from the data storage unit 220 and may generate a call frequency matrix (see FIG. 6) with a horizontal axis (x-axis) representing time and a vertical axis (y-axis) representing a floor on which a hall call occurred. Here, the unit of time is a preset value and may be set by a manager. For example, FIG. 6 shows one of daily matrices generated at 1-minute intervals over a four-week period for an elevator in a four-story building. In the matrix, the numerator represents the number of calls on each floor.

In one embodiment, the denominator N may be a maximum possible frequency of hall calls per minute. Here, the unit of time may be varied depending on settings. That is, the unit of time may be varied depending on the type of analysis method used. A value of N for the first floor and the top floor may be different from a value of N applied to the floors between the first floor and the top floor. For example, in FIG. 6, the value of N applied to the floors between the first floor and the top floor is 6, and the value of N applied to the first floor and the top floor is 6-1, or 5. The maximum possible frequency of hall calls may vary depending on specific properties of a corresponding elevator, such as door speed and rated speed. As an extreme example, the maximum frequency of hall calls occurring within one minute would involve a repeated cycle of a hall call button being pressed, a door being opened and closed without anyone boarding, and then the button being pressed again. In FIG. 6, the maximum possible frequency of hall calls within one minute is calculated to be equal to 6 based on the assumption that the door takes a total of 10 seconds to open and close (5 seconds each). In one embodiment, since the top and bottom floors only have a single hall call button (an “up” hall call button or a “down” hall call button), the maximum possible frequency of hall calls for these floors is set to be one less than that for the intermediate floors. In addition, since a week has seven days, there may be seven different daily matrices.

In one embodiment, the analysis unit 230 generates a matrix of weightings consecutively generated during a preset period of time (for example, for a day, a week, or a month). For example, FIG. 7 shows a weighting matrix for a four-week period. Horizontal and vertical axes of the weighting matrix may correspond to the horizontal and vertical axes of the call frequency matrix described above.

In one embodiment, the weighting may be determined based on a period of time over which statistics are compiled. For example, referring to FIG. 7, since the corresponding data covers a total of four weeks, the weighting is 2/4 when a hall call occurred twice on the third floor at 00:02 for a four-week period.

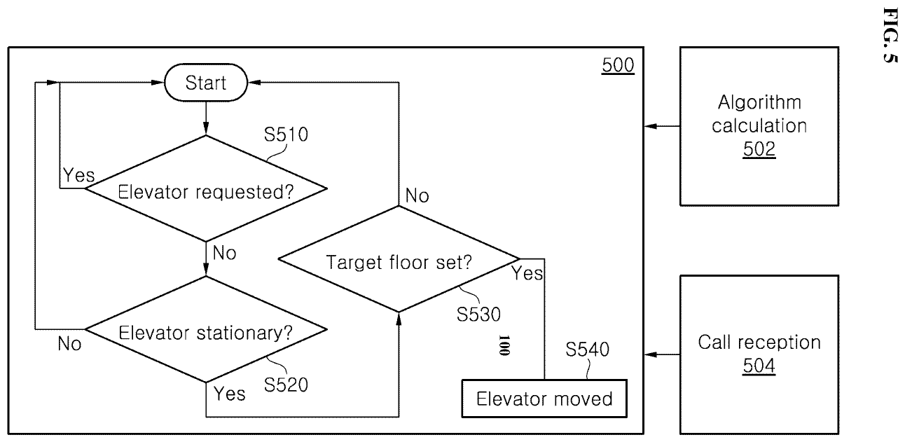

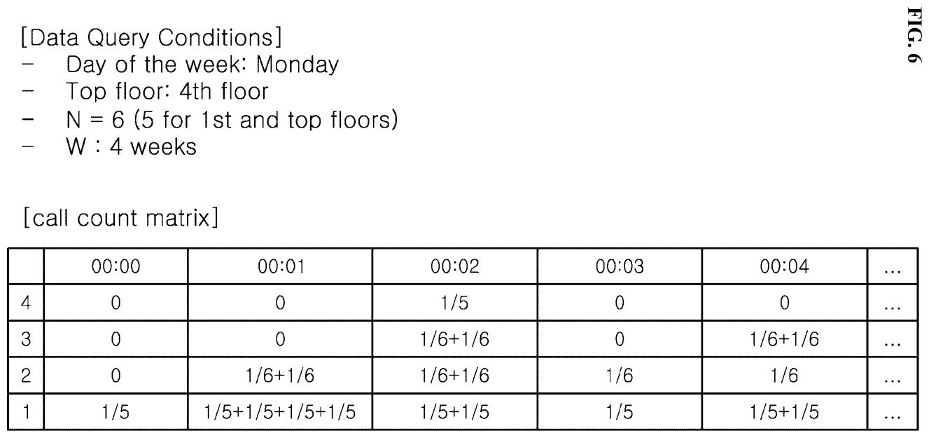

The analysis unit 230 generates a score matrix (see FIG. 8) by multiplying the call frequency matrix by the weighting matrix.

The analysis unit 230 may determine a prospective target floor of the elevator based on the score matrix. For example, the analysis unit 230 may determine that a floor with the highest score is the prospective target floor of the elevator at a corresponding time point. When a determination is made that a score difference between a floor with the highest score and a floor with the second highest score is less than a preset value, the analysis unit 230 may select one of the floors located between the highest-scoring floor and the second-highest-scoring floor as the prospective target floor of the elevator.

The analysis unit 230 may store information about the prospective target floor of the elevator in the data processing unit 240 and/or send the information to the elevator control unit 250. Alternatively, the analysis unit 230 may send the score matrix to the elevator control unit 250, which, in turn, may select the prospective target floor based on the score matrix

FIG. 3 is a block diagram of an elevator control system 300 according to a further embodiment of the present disclosure. Although the elevator control system 300 is shown as a single entity in FIG. 3, it should be understood that components 310, 320, 330, 340 of the elevator control system 300 may be distributed between an edge device 14 and a cloud environment 16, given that the elevator control system 200 includes the edge device 14 and the cloud environment 16.

Referring to FIG. 3, the elevator control system 300 may include a processor 310, a memory 320, a database 330, and a communication unit 340. In one embodiment, the processor 310 may include application specific integrated circuits (ASICs), digital signal processors (DSPs), digital signal processing devices (DSPDs), programmable logic devices (PLDs), field programmable gate arrays (FPGAs), controllers, microcontrollers, microprocessors, or any other suitable processors or controllers for performing the functions described above.

The memory 320 may be configured to store information for operation of the elevator control system 300. The memory 320 may store multiple application programs or applications running on the elevator control system 300 and data/instructions readable by the processor. For example, the memory 320 may include various storage spaces, such as a hard disk drive (HDD), a solid state drive (SSD), a silicon disk drive (SDD), ROM, RAM, EPROM, a flash drive, a hard drive, and a networked cloud. In one embodiment, when the instructions stored in the memory 320 are executed by the processor 310, the method disclosed herein can be performed. In one embodiment, when the instructions stored in the memory 320 are executed by the processor 310, the functions of the analysis unit 230, the data processing unit 240, and the elevator control unit 250 (see FIG. 2) can be performed.

The database 330 may be configured to store instructions executed by the processor 310. The database 330 may include various storage spaces, such as a hard disk drive (HDD), a solid state drive (SSD), a silicon disk drive (SDD), ROM, RAM, EPROM, a flash drive, a hard drive, and a networked cloud. Although the memory 120 and the database 130 have been described as separate components, it should be understood that the memory 120 and the database 130 may be regarded as one and the same component.

In one embodiment, the database 330 may be configured to store information regarding elevator operation and matrices as shown in FIG. 5 to FIG. 7.

The communication unit 340 is configured to communicate with an external device via a network. Here, the communication network may include a network established according to Global System for Mobile communication (GSM), Code Division Multi Access (CDMA), High Speed Downlink Packet Access (HSDPA), High Speed Uplink Packet Access (HSUPA), Long Term Evolution (LTE), Long Term Evolution-Advanced (LTE-A), Wireless LAN (WLAN), Wi-Fi, Wi-Fi-Direct, Digital Living Network Alliance (DLNA), Wireless Broadband (WiBro), or World Interoperability for Microwave Access (WiMAX). However, it should be understood that the present disclosure is not limited thereto and the network may include a network established according to any data transmission protocol that may be developed in the future. In addition, the communication network may include any wired/wireless data communication network.

As the processor 310 executes instructions stored in the memory 320, an artificial intelligence model may be implemented. As used herein, the term “artificial intelligence model” may refer to a model created by training an artificial neural network (ANN) using large volumes of data to optimize parameters within the ANN and to engage in operations of a conversational system (not shown). In one embodiment, an artificial intelligence module (not shown) may be trained through machine reading comprehension (MRC). In one embodiment, an artificial neural network model used in the artificial intelligence module may include at least one of a convolutional neural network (CNN), a deep neural network (DNN), a recurrent neural network (RNN), a restricted Boltzmann machine (RBM), a deep belief network (DBN), a bidirectional recurrent deep neural network (BRDNN), a variational auto encoder (VAE), and a deep Q-network, or a combination thereof, without being limited thereto.

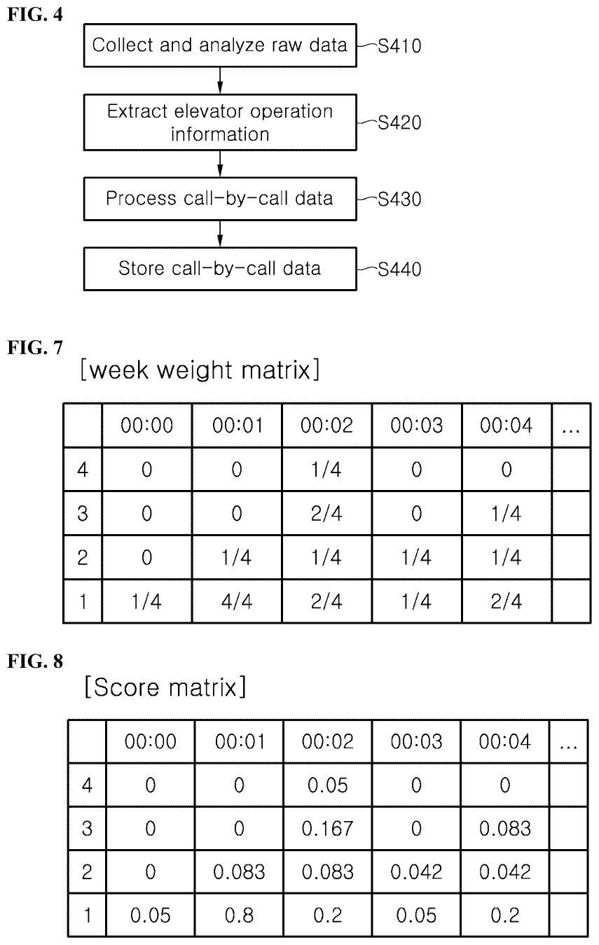

FIG. 4 is a flowchart of a method of storing elevator operation information according to one embodiment of the present disclosure. Although the method of FIG. 4 may be performed by at least one of the edge device 14, the cloud environment 16 (see FIG. 1), and the system 200; 300 (see FIG. 2 or FIG. 3), or a combination thereof, it should be understood that the present disclosure is not limited thereto and the method may be performed by any other suitable device or system than the edge device 14, the cloud environment 16, the system 200; 300, or a combination thereof,

For descriptive convenience, the following description assumes that the method of FIG. 4 is performed by the edge device 14 and the cloud environment 16.

Referring to FIG. 4, in S410, raw data related to elevator calls and/or elevator operation is collected and analyzed. In one embodiment, the elevator management device 12 collects raw data related to elevator calls and/or elevator operation and sends the collected raw data to the edge device 14. The edge device 14 may send the received raw data to the cloud environment 16 at preset time intervals, and the cloud environment 16 may store the raw data. In one embodiment, the edge device 14 may receive and analyze the raw data accumulated in a database of the cloud environment. Alternatively, the cloud environment 16 may analyze the raw data and send results of analysis to the edge device 14. Analysis of the raw data is necessary when required elevator operation information cannot be extracted directly from the raw data, such as when the raw data includes hexadecimal data. Accordingly, when it is possible to extract required elevator operation information directly from the raw data, analysis of the raw data may be omitted. For example, the elevator management device 12 may be configured to send elevator operation information directly to the edge device 14.

In S420, elevator operation information is extracted. The elevator operation information may include a time at which a call (a car call, a hall call) occurred (including date, day of the week, hour, and minute), direction of movement, waiting time, and the like. The elevator operation information may be extracted from the analyzed raw data. Extraction of the elevator operation information may be performed by the edge device 14 or the cloud environment 16.

In S430, the elevator operation information may be processed into call-by-call data. In one embodiment, the edge device 14 or the cloud environment 16 may analyze the elevator operation information to generate call-by-call data including a time at which each call occurred (for example, day of the week, hour, minute), a floor on which each call occurred, and a destination floor. The edge device 14 or the cloud environment 16 may process data generated during a preset period of time to organize data by a method of assigning an ID by matching each call with a time at which the call occurred (for example, day of the week, hour, minute), a floor on which the call occurred, a destination floor, a waiting time, and the like. Alternatively, the call-by-call data may be generated by the elevator management device 12.

In one embodiment, the edge device 14 or the cloud environment 16 may organize the call-by-call data based on at least one of the following: date, holiday, day of the week, hour, minute, destination floor, and call-occurrence floor. The edge device 14 or the cloud environment 16 may extract the call-by-call data on the basis of date, holiday, and day of the week, may extract the call-by-call data on the basis of hour and minute, and may extract the call-by-call data on the basis of destination floor and call-occurrence floor.

In S440, the data processed in S430 is stored. For example, the call-by-call data may be stored in the storage unit of the edge device 14 or the cloud environment 16.

FIG. 5 is a flow diagram of an elevator control method 500 according to one embodiment of the present disclosure. Although the method of FIG. 5 may be performed by at least one of the elevator management device 12, the edge device 14, the cloud environment 16 (see FIG. 1), and the system 200; 300 (see FIG. 2 or FIG. 3), or a combination thereof, it should be understood that the present disclosure is not limited thereto and the method of FIG. 5 may be performed by any other suitable device or system than the elevator management device 12, the edge device 14, the cloud environment 16, the system 200; 300, or a combination thereof. For example, the method 500 of FIG. 5 may be performed by the elevator control unit 250 described above.

Referring to FIG. 5, a method 500 of moving an elevator to a predicted floor is started. In S510, a determination is made as to whether there is a request for the elevator. The request for the elevator may include a car call and a hall call. In response to determining that there is a request for the elevator in S510, the method of moving an elevator to a predicted floor is restarted. In S520, a determination is made as to whether the elevator is stationary. In response to determining that there is no request for the elevator in S510, S520 is performed. In response to determining that the elevator is not stationary in S520, the method of moving an elevator to a predicted floor is restarted. In response to determining that the elevator is stationary in S520, S530 is performed. In S530, a determination is made as to whether there is a prospective target floor for the elevator. In response to determining that there is no prospective target floor for the elevator in S530, the method of moving an elevator to a predicted floor is restarted. In response to determining that there is a prospective target floor for the elevator in S530, S540 is performed. In S540, the elevator is moved to the prospective target floor.

In one embodiment, S510 and S520 may be collectively referred to as a step of determining whether the elevator is in operation. That is, in response to determining that the elevator is already in operation, the elevator continues current operation thereof rather than being moved to the predicted floor and, in response to determining that the elevator is not in operation, the method 500 of moving an elevator to a predicted floor is performed. The method 500 of moving an elevator to a predicted floor may be repeated at preset time intervals. For example, the method 500 may be repeated at time intervals preset by an elevator manager, for example, at time intervals of 1, 3, 5, or 10 minutes.

In one embodiment, a method 502 of calculating an algorithm for predicting a target floor of an elevator may be performed separately from the method 500 of moving an elevator to a predicted floor. Since the method 502 of calculating an algorithm for predicting a target floor of an elevator may be performed based on the stored elevator operation information as described above, detailed description thereof will be omitted. The method 502 of calculating an algorithm for predicting a target floor of an elevator may be repeated at preset time intervals. The reason for this is that elevator operation information can continue to change. The target floor used in S530 of the method 500 of moving an elevator to a predicted floor may be determined according to the method 502 of calculating an algorithm, which is performed separately from the method 500. Information about the target floor may be sent to an entity performing the method 500 of moving an elevator to a predicted floor. For example, the entity performing the method 500 may be any one of the elevator management device 12, the edge device 14, the cloud environment 16, and the system 200; 300. In this way, it is possible to set the target floor used in S530 of the method 500 of moving an elevator to a predicted floor.

In one embodiment, a method 504 of receiving a call from a user who wants to use an elevator may be performed separately from the method 500 of moving an elevator to a predicted floor and/or the method 502 of calculating an algorithm. The call may include a hall call and a car call. The call may be sent to the entity performing the method 500 of moving an elevator to a predicted floor. In response to receiving the call, the entity performing the method 500 may move the elevator according to the call, regardless of whether the elevator is being moved to the prospective target floor according to S540.

The methods according to the present invention may be implemented as code that can be written on a processor-readable recording medium and thus read by a processor of a server, system, equipment, computer, or integrated control unit which is used by a certain entity. The processor-readable recording medium may be any type of recording device in which data is stored in a processor-readable manner. The processor-readable recording medium may include, for example, ROM, RAM, CD-ROM, a magnetic tape, a floppy disk, and an optical data storage device, and may be implemented in the form of a carrier wave transmitted over the Internet. In addition, the processor-readable recording medium may be distributed over a plurality of computer systems connected to a network such that processor-readable code is written thereto and executed therefrom in a decentralized manner.

The devices and methods described above may be implemented by a hardware component, a software component, and/or a combination thereof. For example, the devices and components described in the embodiments may be implemented using one or more general-purpose computers or special-purpose computers, such as a processor, a controller, an arithmetic logic unit (ALU), a digital signal processor, a microcomputer, a field programmable array (FPA), a programmable logic unit (PLU), a microprocessor, or any other device capable of executing and responding to instructions. The processing device may execute an operating system (OS) and one or more software applications executable on the operating system. The processing device may also access, store, manipulate, process, and generate data in response to execution of software. For convenience of understanding, the processing device is sometimes described as utilizing a single processing element, but a person having ordinary skill in the art will recognize that the processing device may include multiple processing elements and/or multiple types of processing elements. For example, the processing device may include multiple processors, or may include one processor and one controller. Further, another processing configuration such as a parallel processor is possible.

The software may include computer programs, code, instructions, or a combination thereof. The software may configure the processing device to operate as desired, or may independently or collectively instruct the processing device. The software and/or data may be permanently or temporarily embodied in any type of machine, component, physical device, virtual equipment, computer storage medium or device, or transmitted signal wave, for interpretation by the processing device or for providing instructions or data to the processing device. The software may also be distributed across networked computer systems to be stored or executed in a decentralized manner. The software and the data may be stored on one or more computer-readable recording media.

The embodiments of the present invention may be practiced in a distributed computing environment where certain tasks are performed by remote processing devices connected via a communication network. In the distributed computing environment, program modules may be located on both local and remote memory storage devices.

While the preferred embodiments of the present invention have been described with reference to the drawings as above, it should be understood that the foregoing embodiments are provided for illustration only and are not to be in any way construed as limiting the present invention, and that various modifications, changes, alterations, and equivalent embodiments can be made by those skilled in the art without departing from the spirit and scope of the disclosure. For example, even when the invention described herein is performed in a different order than described herein and/or the components of the described systems, structures, devices, circuits, etc. are combined or assembled in a different form than described herein or are substituted or replaced by other components or equivalents thereto, suitable results can be achieved.

Therefore, other implementations, other embodiments, and equivalents to the appended claims fall within the scope of the claims.

1. An elevator control system comprising:
a data processing unit configured to process elevator operation information;
a data storage unit configured to store the elevator operation information, the elevator operation information comprising call-by-call data comprising a date and time at which each call occurred and a floor on which each call occurred;
an analysis unit configured to predict a target floor of an elevator based on the elevator operation information; and
an elevator control unit configured to move the elevator to the predicted target floor.

2. The elevator control system according to claim 1, wherein the analysis unit is configured to organize the call-by-call data on a daily basis to generate a call count matrix with a horizontal axis representing time and a vertical axis representing a floor on which each call occurred.

3. The elevator control system according to claim 2, wherein the analysis unit is configured to generate a weighting matrix having the same dimensionality as the call count matrix based on a period of time over which the elevator operation information is compiled and to generate a score matrix by multiplying the call count matrix by the weighting matrix.

4. The elevator control system according to claim 1, wherein the elevator control unit is configured to determine whether the elevator is in operation and to move the elevator to the target floor in response to determining that the elevator is not in operation.

5. The elevator control system according to claim 4, wherein the elevator control unit is configured to receive an elevator call from a user and to operate the elevator based on the elevator call, regardless of whether the elevator is being moved to the target floor, in response to receiving the elevator call.

6. The elevator control system according to claim 1, wherein the data storage unit is configured to group the call-by-call data on the basis of at least one of day of the week, time, and destination floor and to store the grouped data.

7. An elevator control method using an elevator control system, comprising:
receiving and storing elevator operation information;
analyzing the elevator operation information to generate call-by-call data comprising a floor on which each elevator call occurred and a time at which each elevator call occurred;
generating a call count matrix with a horizontal axis representing time and a vertical axis representing a floor on which each elevator call occurred, based on the call-by-call data;
predicting a target floor of an elevator based on the call count matrix; and
moving the elevator to the target floor.

8. The elevator control method according to claim 7, wherein the step of predicting a target floor of an elevator based on the call count matrix comprises:
generating a weighting matrix having the same dimensionality as the call count matrix based on a period of time over which the elevator operation information is compiled;
generating a score matrix by multiplying the call count matrix by the weighting matrix; and
predicting a target floor of the elevator based on the score matrix.

9. The elevator control method according to claim 7, further comprising:
receiving an elevator call from a user; and
operating the elevator based on the elevator call, regardless of whether the elevator is being moved to the target floor, in response to receiving the elevator call.

10. The elevator control method according to claim 7, wherein the step of generating a call count matrix with a horizontal axis representing time and a vertical axis representing a floor on which each elevator call occurred based on the call-by-call data comprises:
grouping the call-by-call data on the basis of at least one of day of the week, time, and destination floor and storing the grouped data.
